(19) United States
(12) Patent Application Publication
(10) Pub. No.: US 2025/0155382 A1
(43) Pub. Date: May 15, 2025

(54) INTERPRETATION DEVICE, INTERPRETATION METHOD, AND NON-TRANSITORY STORAGE MEDIUM STORING PROGRAM

(71) Applicant: SAMSUNG ELECTRONICS CO., LTD., Suwon-si (KR)

(72) Inventors: Koji Murata, Yokohama-shi (JP); Jaeyong Lee, Yokohama-shi (JP); Yukihide Tsuji, Yokohama-shi (JP); Yoshinori Sasai, Yokohama-shi (JP)

(21) Appl. No.: 18/805,677

(22) Filed: Aug. 15, 2024

(30) Foreign Application Priority Data
Nov. 9, 2023 (JP) 2023-191451

(51) Int. Cl. G01N 23/20

(52) U.S. Cl. CPC G01N 23/20

(57) ABSTRACT

An example interpretation device includes an extraction circuit and a calculation circuit. The extraction circuit is configured to extract, from mesh data representing a target structure, parameters of each primitive structure that consists of a plurality of meshes corresponding to the same electron density. The calculation circuit is configured to calculate an analytical solution for a scattering intensity distribution of X-rays irradiated to each primitive structure based on the parameters of each primitive structure, and to calculate a scattering intensity distribution of the X-rays irradiated to the target structure based on the parameters of each primitive structure.

### CROSS-REFERENCE TO RELATED APPLICATION

This application claims priority from Japanese Patent Application No. 2023-191451 filed on Nov. 9, 2023 and all the benefits accruing therefrom under 35 U.S.C. 119, the disclosure of which is herein incorporated by reference in its entirety.

### BACKGROUND

In related art, a measurement technology uses transmission-type incineration X-ray scattering technology.

It is desired to reduce the time to analyze the distribution of X-ray scattering intensities.

### SUMMARY

The present disclosure relates to an interpretation device, an interpretation method, and a non-transitory storage medium storing a program for performing the interpretation method, which reduce the time required for analyzing the distribution of X-ray scattering intensities.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

In some implementations, an interpretation device comprises an extraction unit configured to extract, from mesh data representing a target structure, parameters of each primitive structure that consists of a plurality of meshes corresponding to the same electron density, and a calculation unit configured to calculate an analytical solution for a scattering intensity distribution of X-rays irradiated to each primitive structure based on the parameters, and to calculate a scattering intensity distribution of the X-rays irradiated to the target structure based on the parameters.

In some implementations, an interpretation method, performed by executing a program stored in a memory via a processor, comprises extracting, from mesh data representing a target structure, parameters of each primitive structure that consists of a plurality of meshes corresponding to the same electron density, calculating an analytical solution for a scattering intensity distribution of X-rays irradiated to the target structure, based on the parameters, and calculating a scattering intensity distribution of X-rays irradiated to the target structure, based on the parameters.

In some implementations, an non-transitory computer-readable storage medium, storing a program that performs an interpretation method when executed by a processor, comprises extracting, from mesh data representing a target structure, parameters of each primitive structure that consists of a plurality of meshes corresponding to the same electron density, calculating an analytical solution for a scattering intensity distribution of X-rays irradiated to the target structure, based on the parameters, and calculating a scattering intensity distribution of X-rays irradiated to the target structure, based on the parameters.

According to the aforementioned and other implementations of the present disclosure, it is possible to provide an interpretation device, an interpretation method, and a non-transitory storage medium storing a program for performing the interpretation method, which reduce the time required for analyzing the distribution of X-ray scattering intensities.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail implementations thereof with reference to the attached drawings.

FIG. 1 is an example diagram for explaining a scattering vector when X-rays are irradiated onto a target structure.

FIG. 2 is a block diagram illustrating an example of an interpretation device.

FIG. 3 is a diagram for explaining an example of a target structure.

FIG. 4 is an example diagram for explaining the state after the fusion of meshes.

FIG. 5 is a perspective view illustrating a first example of a target structure.

FIG. 6 shows the results of verification obtained by an example of an interpretation method according to Implementation 1.

### DETAILED DESCRIPTION

For clarity of explanation, appropriate omissions and simplifications have been made to the following description and the accompanying drawings. Moreover, in each of the drawings, the same elements are assigned the same reference signs, and redundant descriptions have been omitted, as necessary.

Firstly, the circumstances that have led to the concept according to the present disclosure will hereinafter be described.

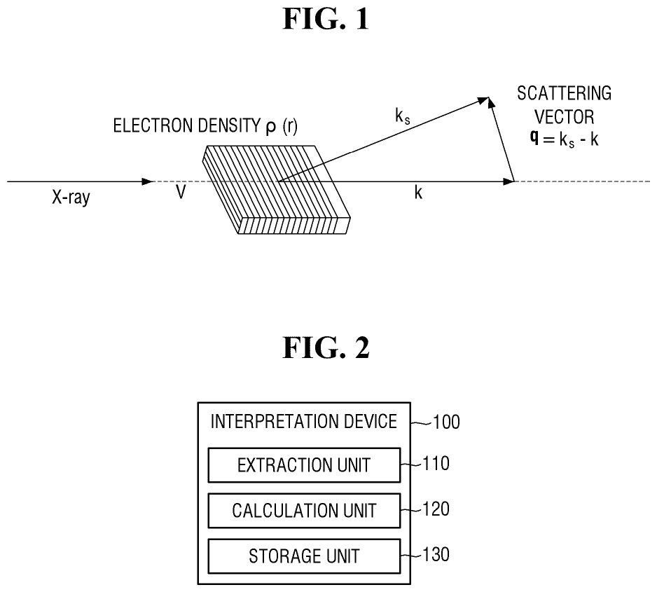

FIG. 1 is an example diagram for explaining a scattering vector when plane wave X-rays are irradiated onto a target structure with periodicity.

In the formulas or expressions that will be presented below, boldface letters represent vectors. It is noted that in the present disclosure where boldface cannot be used, the letters representing vectors are followed by “(bold).”

The wave vector of X-rays is represented as k (or k(bold)) and the wave vector of scattered waves is represented as ks (or ks(bold)). A scattering vector q (or q(bold)) is defined as ks−k. In this case, a scattering intensity distribution I(q) is expressed as the square of a three-dimensional (3D) Fourier transform obtained by solving the Schrödinger equation with the Born approximation, as shown in Equation 1 below.

$$Equation 1$$

$$I ( q ) = {\vert \frac{1}{V} \int \int {\int }_{V} ρ ( r ) exp ( - iq \cdot r ) {d}^{3} r \vert}^{2} \qquad ( 1 )$$

Then, when the incident X-rays possess a spread represented by W(k(bold)), a smeared scattering intensity distribution Iₛₘₑₐᵣ(q(bold)) is calculated as a two-dimensional (2D) convolution integral of the scattering intensity distribution I(q(bold)) and the spread W(k(bold)), as shown in Equation 2. While the smeared scattering intensity distribution Iₛₘₑₐᵣ(q(bold)) is a 2D convolution integral, the scattering intensity distribution I(q(bold)) is a 3D Fourier transform. Therefore, typically, the time taken to calculate the scattering intensity distribution I(q(bold)) is longer than the time taken to calculate the smeared scattering intensity distribution Iₛₘₑₐᵣ(q(bold)).

$$Equation 2$$

$${I}_{smear} ( q ) = \int \int W ( k ) I ( q - k ) {d}^{2} k \qquad ( 2 )$$

Generally, the scattering intensity distribution I(q(bold)) is calculated for a target structure modeled as a combination of primitive shapes such as rectangles or cylinders, for which a 3D Fourier transform can be solved analytically. However, structure data obtained by process simulations reflecting physical processes or by topography simulations typically cannot be represented simply by such primitive shapes and need to be represented by meshes.

It is known that the analytical solution for a scattering intensity distribution of X-rays irradiated on a rectangular mesh can be calculated, and the scattering intensity distribution of X-rays irradiated on the target structure is obtained by summing such analytical solutions across the whole region. Equation 3 represents a scattering intensity distribution F(q) of X-rays irradiated onto a target structure represented by a rectangular mesh. Meanwhile, a Z-axis direction represents the direction of incidence of the X-rays.

$$Equation 3$$

$$F ( q ) = \frac{1}{{L}_{x} {L}_{y} {L}_{z}} {\sum }_{i = 0}^{{N}_{x} - 1} {\sum }_{j = 0}^{{N}_{y} - 1} {\sum }_{k = 0}^{{N}_{z} - 1} {ρ}_{ljk} sinc \frac{{q}_{x} Δ {x}_{i}}{2} sinc \frac{{q}_{y} Δ {y}_{j}}{2} sinc \frac{{q}_{z} Δ {z}_{k}}{2} exp ( - iq \cdot {r}_{ijk} ) Δ {x}_{i} Δ {y}_{j} Δ {z}_{k} \qquad ( 3 )$$

Referring to Equation 3, qₓ, q_{y}, and q_{z} represent the X-, Y-, and Z-axis components, respectively, of the scattering vector q, Lₓ, L_{y}, and L_{z} represent the widths of an interpretation region in the X-, Y-, and Z-axis directions, respectively, Nₓ, N_{y}, and N_{z} represent the numbers of meshes (also referred to as cells) in the X, Y, and Z directions, respectively, i, j, and k represent the mesh numbers of each mesh in the X, Y, and Z directions, respectively, rᵢⱼₖ (or r(bold)ijk) represents a position vector for the central coordinates of each mesh, and ρᵢⱼₖ represents the electron density corresponding to each mesh.

Therefore, when there are a large number of meshes representing the target structure, there is a challenge due to the time required to analyze the scattering intensity distribution (F(q)). To address this, the present disclosure provides an interpretation device, an interpretation method, and a program that reduce the time required to analyze the scattering intensity distribution of plane wave X-rays irradiated onto a complex structure represented by meshes.

FIG. 2 is a block diagram illustrating an example of an interpretation device 100.

Referring to FIG. 2, an interpretation device 100 may be a computer device that operates by executing a program stored in a memory by a processor. The interpretation device 100 may be composed of a plurality of computer devices. In this case, the components or functions constituting the interpretation device 100 may be distributed and deployed across the plurality of computer devices. The plurality of computers may be connected through a network or directly connected via cables. As the processor, a central processing unit (CPU), a graphics processing unit (GPU), or a field-programmable gate array (FPGA) may be used.

The interpretation device 100 is equipped with an extraction unit 110, a calculation unit 120, and a storage unit 130. The storage unit 130 may be realized by a memory device accessible by the processor.

The extraction unit 110 extracts parameters of a primitive structure composed of a plurality of meshes corresponding to the same electron density (i.e., the same material) from mesh data representing the target structure. The primitive structure is a structure from which the analytical solution of the scattering intensity distribution (F(q)) of X-rays irradiated onto the target structure can be calculated, such as, for example, a rectangle, a cylinder, etc.

For example, if the primitive structure is a rectangle, the parameters may include the dimensions in the X-, Y-, and Z-axis directions of the rectangle. The parameters may include the central coordinates of the rectangle. For example, if the primitive structure is a cylinder, the parameters may include the radius, height, etc. The parameters may include the central coordinates of the cylinder.

The calculation unit 120 calculates the scattering intensity distribution (F(q)) of X-rays irradiated onto the target structure based on the parameters extracted by the extraction unit 110. For example, if the target structure includes multiple primitive structures, the calculation unit 120 may calculate an analytical solution based on the parameters for each of the primitive structures and may calculate the scattering intensity distribution as the sum of the analytical solutions.

Equation 3 above is derived based on the assumption that the target structure is represented as a 3D array of rectangular meshes. However, since the scattering intensity distribution (F(q)) is calculated as the sum of analytical solutions for the Fourier transform for each mesh, the target structure is not necessarily represented as a 3D array as long as it is accurately represented. Also, the size of the rectangular meshes is not necessarily minute. Therefore, the calculation unit 120 may also calculate the scattering intensity distribution, as indicated by Equation 4 below.

$$Equation 4$$

$$F ( q ) = \frac{1}{{L}_{x} {L}_{y} {L}_{z}} {\sum }_{l = 0}^{N - 1} {ρ}_{l} sinc \frac{{q}_{x} Δ {x}_{l}}{2} sinc \frac{{q}_{y} Δ {y}_{l}}{2} sinc \frac{{q}_{z} Δ {z}_{l}}{2} exp ( - iq \cdot {r}_{l} ) Δ {x}_{l} Δ {y}_{l} Δ {z}_{l} \qquad ( 4 )$$

Referring to Equation 4, N represents the total number of meshes included in the target structure after fusion by the extraction unit 110. The amount of calculation using Equation 4 becomes N/(NxNyNz) times that of using Equation 3. Additionally, ρₗ indicates the electron density of an l-th mesh, Δxl, Δyl, and Δzl represent the lengths of the edges of the l-th mesh in the X-, Y-, and Z-axis directions, respectively, and rₗ represents the central coordinates of the l-th mesh.

Furthermore, the calculation unit 120 may also calculate the scattering intensity distribution (F(q)) based on a reference electron density, which is the electron density corresponding to a greater number of primitive structures than other electron densities. That is, the calculation unit 120 may subtract the reference electron density from the electron density corresponding to each primitive structure and may calculate the scattering intensity distribution based on the results of the subtraction, as indicated by Equation 5 below.

$$Equation 5$$

$$F ( q ) = \frac{1}{V} {\sum }_{l = 0}^{N - 1} {ρ}_{l}^{′} sinc \frac{{q}_{x} Δ {x}_{l}}{2} sinc \frac{{q}_{y} Δ {y}_{l}}{2} sinc \frac{{q}_{z} Δ {z}_{l}}{2} exp ( - iq \cdot {r}_{l} ) Δ {v}_{l} + {ρ}_{ref} sinc \frac{{q}_{x} {L}_{x}}{2} sinc \frac{{q}_{y} {L}_{y}}{2} sinc \frac{{q}_{z} {L}_{z}}{2} exp ( - iq \cdot {r}_{ref} ) \qquad ( 5 )$$

Referring to Equation 5, ρₗ′=ρₗ−ρ_{ref}, ρ_{ref} represents the reference electron density, Δvₗ=ΔxₗΔyₗAzₗ, V=LₓL_{y}L_{z}, and r_{ref} (or r(bold)_{ref}) represents the position vector of the center of each interpretation region (e.g., the center of the target structure).

When the reference electron density ρ_{ref} corresponds to a large number of meshes, the value of (ρₗ−ρ_{ref}) becomes zero for the corresponding meshes, thus making the calculation for the meshes unnecessary. The number of primitive structures corresponding to the reference electron density ρ_{ref} may be greater than the number of primitive structures corresponding to any other electron density. Additionally, the setting of the reference electron density ρ_{ref} may be conducted before the processing performed by the extraction unit 110. In this case, the number of meshes corresponding to the reference electron density ρ_{ref} may be greater than the number of meshes corresponding to any other electron density. Furthermore, the reference electron density ρ_{ref} may be set for each substructure included in the target structure. Meanwhile, the reference electron density ρ_{ref} may also be set by a user of the interpretation device 100.

When the target structure includes multiple substructures with matching electron densities, the calculation unit 120 may calculate analytical solutions for each substructure using the parameters extracted for other substructures. Specifically, if the target structure includes first and second substructures with matching electron densities, the extraction unit 110 records the parameters of a primitive structure included in the first substructure in the storage unit 130. Then, the calculation unit 120 calculates analytical solutions using the parameters read from the storage unit 130 as the parameters of a primitive structure included in the second substructure. Additionally, the calculation unit 120 may assign the process of calculating analytical solutions for each of a plurality of primitive structures to any of a plurality of processor cores and may execute parallel processing across the plurality of processor cores.

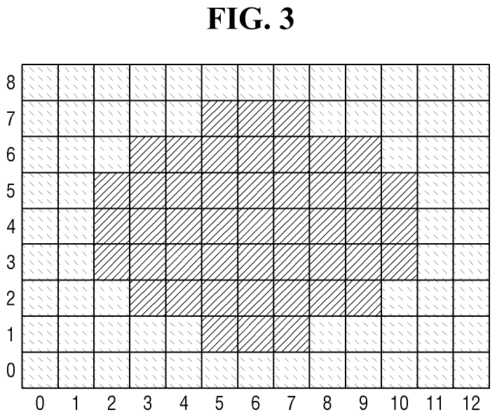

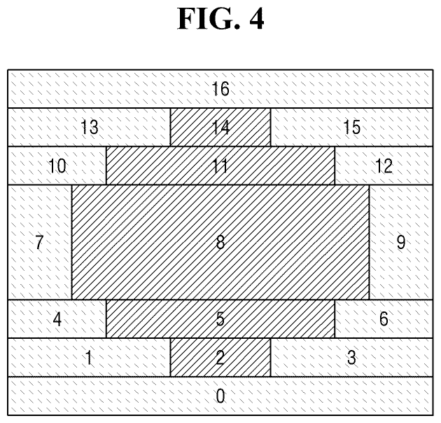

The operation of the interpretation device 100 will hereinafter be described with reference to FIGS. 3 and 4. FIG. 3 depicts an example of a target structure represented by rectangular meshes.

For convenience, referring to FIG. 3, the target structure is represented two-dimensionally. Meshes with the same hatching correspond to the same material, i.e., the same electron density. There are 13 meshes in a horizontal direction and 9 meshes in a vertical direction, making a total of 117 meshes representing the target structure.

The extraction unit 110 of the interpretation device 100 fuses adjacent meshes in the horizontal direction that have the same electron density. Then, the extraction unit 110 fuses adjacent meshes in the vertical direction that have the same electron density and the same position and size in the horizontal direction, resulting in the creation of a rectangular parallelepiped composed of multiple meshes with the same electron density. Alternatively, the extraction unit 110 may fuse adjacent meshes in the vertical direction first and then fuse adjacent meshes in the horizontal direction.

FIG. 4 is an example diagram for explaining the state after the fusion of the meshes of FIG. 3 by the extraction unit 110.

Referring to FIG. 4, the target structure is represented by 17 meshes, i.e., meshes 0 through 16, and the extraction unit 110 extracts parameters from the 17 meshes. Then, the calculation unit 120 of the interpretation device 100 calculates the scattering intensity distribution (F(q)) based on the extracted parameters. Specifically, the calculation unit 120 calculates the scattering intensity distribution as the sum of analytical solutions based on the parameters of meshes.

The calculation unit 120 of the interpretation device 100 may calculate the scattering intensity distribution using Equation 5, based on the electron density corresponding to meshes 0, 1, 3, 4, 6, 7, 9, 10, 12, 13, 15, and 16 as the reference electron density (ρ_{ref}).

In FIG. 3, the target structure is represented by 117 (=13*9) meshes, while in FIG. 4, the target structure is represented by 17 meshes. Consequently, the speed of calculation increases by a factor of 6.9=(117/17). Moreover, when the calculation unit 120 calculates the scattering intensity distribution based on the reference electron density, the number of meshes required for the calculation is reduced to 5, thereby increasing the calculation speed by a factor of 23 (=117/5).

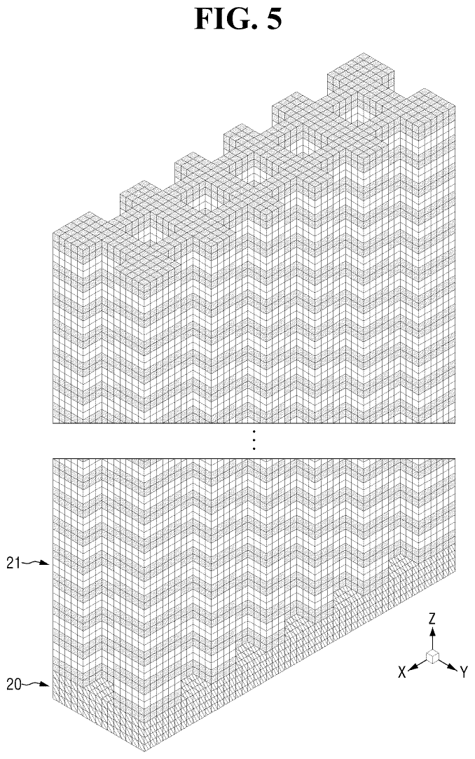

The inventor(s) of the present disclosure have considered the calculation of the scattering intensity distribution when X-rays are irradiated onto a 3D target structure schematically depicted in FIG. 5. FIG. 5 depicts meshes coarsely compared to the actual target structure used for consideration. Referring to FIG. 5, there are rectangular holes in a multilayer film 21 on a substrate 20, which is in the shape of a rectangular parallelepiped. The substrate 20 and the multilayer film 21 are stacked in the Z-axis direction. Cells with the same hatching correspond to the same material, i.e., the same electron density.

Firstly, the inventor(s) fused meshes corresponding to the same electron density and adjacent in the Z-axis direction. Thereafter, the inventor(s) fused meshes corresponding to the same electron density and adjacent in the X-axis direction. Thereafter, the inventor(s) fused meshes corresponding to the same electron density and adjacent in the Y-axis direction. Thereafter, the inventor(s) created list information that lists information regarding the fused meshes. The list information includes, for example, the central coordinates of each mesh after fusion, the lengths of the edges of each mesh, and the electron density corresponding to each mesh.

For example, the lengths of the edges of each mesh correspond to the aforementioned parameters. Thereafter, the inventor(s) set the electron density corresponding to a largest number of meshes as the reference electron density ρ_{ref} and calculated the scattering intensity distribution using Equation 5. Here, the order of mesh fusion directions may be changed. The order of the mesh fusion directions may be decided by the user or determined internally by the interpretation device 100. Additionally, the reference electron density ρ_{ref} may be determined before mesh fusion.

Although FIG. 5 represents the target structure with meshes coarsely, the target structure is divided into 526 sections in the X-axis direction, 152 sections in the Y-axis direction, and 5200 sections in the Z-axis direction. The inventor(s) set 526 sampling points and 152 sampling points for the X-axis component (qₓ[1/nm]) and Y-axis component (q_{y}[1/nm]), respectively, of the scattering vector q. When using a related technique in connection with the present implementation, i.e., when using Equation 4 without fusing layers with matching electron density patterns, the calculation time for the scattering intensity distribution was 11147 sec. On the other hand, when fusing layers with matching electron densities with the reference electron density set appropriately, the calculation time for the scattering intensity distribution was 1 sec. This means that the present implementation can enhance the calculation speed 1592.4 times, even considering the amount of time required for preprocessing, including mesh fusion and the setting of the reference electron density, which is 6 sec.

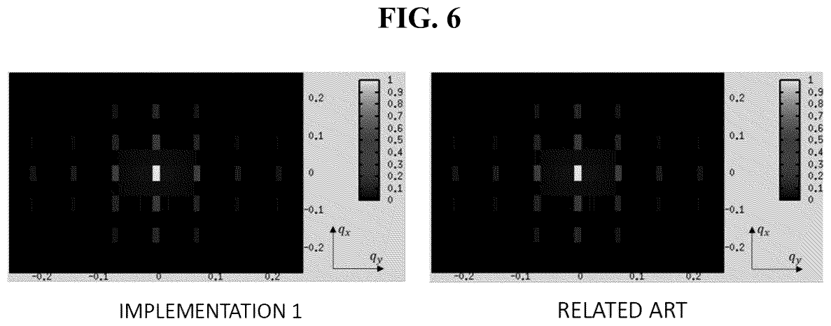

Furthermore, FIG. 6 shows that the results of the calculation of the scattering intensity distribution using the present implementation (“Implementation 1”) and using the related technique (“Related Art”) match. For clarity and convenience, the square root of the scattering intensity distribution for the major components of the scattering vector q is depicted, and the scattering intensity distribution is normalized so that it becomes 1 at qₓ=q_{y}=0. The maximum absolute value of the difference at each point between the calculation results from the present implementation and the calculation results from the related technique across the entire calculated region is as sufficiently small as 1.0*e−13.

The present implementation can reduce the calculation time by using the parameters of each primitive structure into which multiple meshes are fused. Moreover, the calculation time can be further reduced by using the reference electron density.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The present disclosure is not limited to the implementations set forth herein and can be modified without departing from the spirit of the disclosure.

What is claimed is:

1. An interpretation device comprising:
an extraction circuit configured to extract, from mesh data representing a target structure, a plurality of parameters of each primitive structure of a plurality of primitive structures, each primitive structure including a plurality of meshes corresponding to a same electron density; and
a calculation circuit configured to
calculate an analytical solution for a scattering intensity distribution of X-rays irradiated to each primitive structure based on the plurality of parameters of each primitive structure, and
calculate a scattering intensity distribution of X-rays irradiated to the target structure based on the plurality of parameters of each primitive structure.

2. The interpretation device of claim 1, wherein
the target structure includes the plurality of primitive structures, and
the calculation circuit is configured to
for each primitive structure of the plurality of primitive structures, assign, to a processor core of a plurality of processor cores, a process of calculating the analytical solution, and
execute parallel processing across the plurality of processor cores.

3. The interpretation device of claim 1, wherein
the calculation circuit is configured to calculate the scattering intensity distribution based on a reference electron density, and
the plurality of primitive structures corresponds to a plurality of electron densities including the reference electron density, and the reference electron density corresponds to a larger number of primitive structures or meshes than other electron densities in the plurality of electron densities.

4. The interpretation device of claim 1, wherein
the target structure includes a first substructure and a second substructure, the first substructure and the second substructure having a matching electron density pattern,
the extraction circuit is configured to record, in a storage device, the plurality of parameters of a primitive structure included in the first substructure, and
the calculation circuit is configured to use, as the plurality of parameters of a primitive structure included in the second substructure, the plurality of parameters of the primitive structure included in the first substructure read from the storage device.

5. The interpretation device of claim 4, wherein
the target structure includes the plurality of primitive structures, and
the calculation circuit is configured to
for each primitive structure of the plurality of primitive structures, assign, to a processor core of a plurality of processor cores, a process of calculating an analytical solution, and
execute parallel processing across the plurality of processor cores.

6. The interpretation device of claim 4, wherein
the calculation circuit is configured to calculate the scattering intensity distribution based on a reference electron density, and
the plurality of primitive structures corresponds to a plurality of electron densities including the reference electron density, and the reference electron density corresponds to a larger number of primitive structures or meshes than other electron densities in the plurality of electron densities.

7. The interpretation device of claim 6, wherein a number of primitive structures or meshes corresponding to the reference electron density is greater than or less than a number of primitive structures or meshes corresponding to other electron densities in the plurality of electron densities.

8. The interpretation device of claim 1, wherein the scattering intensity distribution of X-rays is represented by Equation F(q)
$$F ( q ) = \frac{1}{{L}_{x} {L}_{y} {L}_{z}} {\sum }_{i = 0}^{{N}_{x} - 1} {\sum }_{j = 0}^{{N}_{y} - 1} {\sum }_{k = 0}^{{N}_{z} - 1} {ρ}_{ljk} sinc \frac{{q}_{x} Δ {x}_{i}}{2} sinc \frac{{q}_{y} Δ {y}_{j}}{2} sinc \frac{{q}_{z} Δ {z}_{k}}{2} exp ( - iq \cdot {r}_{ijk} ) Δ {x}_{i} Δ {y}_{j} Δ {z}_{k} \qquad ( 3 )$$
where qₓ, q_{y}, and q_{z} represent X-, Y-, and Z-axis components, respectively, of a scattering vector q, Lₓ, L_{y}; L_{z} represent widths of an interpretation region in the X-, Y-, and Z-axis directions, respectively; Nₓ, N_{y}, and N_{z} represent numbers of meshes in the X, Y, and Z directions, respectively; i, j, and k represent mesh numbers of each mesh in the X, Y, and Z directions, respectively; rᵢⱼₖ represents a position vector for central coordinates of each mesh; and ρᵢⱼₖ represents an electron density corresponding to each mesh.

9. The interpretation device of claim 1, wherein the target structure is represented by a rectangular mesh.

10. The interpretation device of claim 1, wherein the target structure is represented by a 3D array of rectangular meshes.

11. The interpretation device of claim 1, wherein the scattering intensity distribution of X-rays is represented by Equation F(q)
$$F ( q ) = \frac{1}{{L}_{x} {L}_{y} {L}_{z}} {\sum }_{l = 0}^{N - 1} {ρ}_{l} sinc \frac{{q}_{x} Δ {x}_{l}}{2} sinc \frac{{q}_{y} Δ {y}_{l}}{2} sinc \frac{{q}_{z} Δ {z}_{l}}{2} exp ( - iq \cdot {r}_{l} ) Δ {x}_{l} Δ {y}_{l} Δ {z}_{l} \qquad ( 4 )$$
where N represents a total number of meshes included in the target structure after fusion by the extraction unit; ρₗ indicates an electron density of an l-th mesh; Δxₗ, Δyₗ, and Δzₗ represent lengths of edges of the l-th mesh in the X-, Y-, and Z-axis directions, respectively; and rₗ represents central coordinates of the l-th mesh.

12. The interpretation device of claim 1, wherein the scattering intensity distribution of X-rays is represented by Equation F(q)
$$F ( q ) = \frac{1}{V} {\sum }_{l = 0}^{N - 1} {ρ}_{l}^{′} sinc \frac{{q}_{x} Δ {x}_{l}}{2} sinc \frac{{q}_{y} Δ {y}_{l}}{2} sinc \frac{{q}_{z} Δ {z}_{l}}{2} exp ( - iq \cdot {r}_{l} ) Δ {v}_{l} + {ρ}_{ref} sinc \frac{{q}_{x} {L}_{x}}{2} sinc \frac{{q}_{y} {L}_{y}}{2} sinc \frac{{q}_{z} {L}_{z}}{2} exp ( - iq \cdot {r}_{ref} ) \qquad ( 5 )$$
where ρₗ′=ρₗ−ρ_{ref}; ρₗ indicates an electron density of an l-th mesh; ρ_{ref} represents a reference electron density; Δvₗ=ΔxₗΔyₗΔzₗ; V=LₓL_{y}L_{z}; and r_{ref} represents a position vector of a center of each interpretation region.

13. The interpretation device of claim 12, wherein the reference electron density ρ_{ref} corresponds to a large number of meshes, the value of (ρₗ−ρ_{ref}) becomes zero for the corresponding meshes, and a number of primitive structures corresponding to the reference electron density ρ_{ref} is greater than a number of primitive structures corresponding to any other electron density.

14. The interpretation device of claim 12, wherein the reference electron density ρ_{ref} is set for each substructure included in the target structure.

15. An interpretation device comprising:
extracting, from mesh data representing a target structure, a plurality of parameters of each primitive structure of a plurality of primitive structures, each primitive structure including a plurality of meshes corresponding to a same electron density;
calculating an analytical solution for a scattering intensity distribution of X-rays irradiated to the target structure based on the plurality of parameters of each primitive structure; and
calculating a scattering intensity distribution of X-rays irradiated to the target structure based on the plurality of parameters of each primitive structure.

16. The interpretation device of claim 15, wherein
the target structure includes a first substructure and a second substructure, the first substructure and the second substructure having a matching electron density pattern,
extracting the plurality of parameters of each primitive structure comprises recording, in a storage device, the plurality of parameters of a primitive structure included in the first substructure, and
calculating the scattering intensity distribution comprises using, as the plurality of parameters of a primitive structure included in the second substructure, the plurality of parameters of the primitive structure included in the first substructure read from the storage device.

17. The interpretation device of claim 16, wherein
the target structure includes the plurality of primitive structures, and
calculating the analytical solution comprises
for each primitive structure of the plurality of primitive structures, assigning, to a processor core of a plurality of processor cores, a process of calculating the analytical solution, and
executing parallel processing across the plurality of processor cores.

18. The interpretation device of claim 16, wherein
the scattering intensity distribution is calculated based on a reference electron density, and
the plurality of primitive structures corresponds to a plurality of electron densities including the reference electron density, and the reference electron density corresponds to a larger number of primitive structures or meshes than other electron densities in the plurality of electron densities.

19. The interpretation device of claim 18, wherein a number of primitive structures or meshes corresponding to the reference electron density is greater than or less than a number of primitive structures or meshes corresponding to any other electron density in the plurality of electron densities.

20. The interpretation device of claim 15, wherein
the scattering intensity distribution is calculated based on a reference electron density, and
the plurality of primitive structures corresponds to a plurality of electron densities including the reference electron density, and the reference electron density corresponds to a larger number of primitive structures or meshes than other electron densities in the plurality of electron densities.
